(19) United States
(12) Patent Application Publication
(10) Pub. No.: US 2015/0054767 A1
(43) Pub. Date: Feb. 26, 2015

(54) ELECTRONIC DEVICE AND METHOD OF CONTROLLING TOUCH REACTIVITY OF ELECTRONIC DEVICE

(71) Applicant: Samsung Electronics Co., Ltd., Gyeonggi-do (KR)

(72) Inventors: Da-Hee Lim, Gyeonggi-do (KR); Ki-Won Kim, Gyeonggi-do (KR); Seung-Min Chung, Seoul (KR)

(21) Appl. No.: 14/466,065

(22) Filed: Aug. 22, 2014

(30) Foreign Application Priority Data
Aug. 22, 2013 (KR) 10-2013-0099694

(51) Int. Cl. G06F 3/041

(52) U.S. Cl. CPC G06F 3/0416; G06F 3/0412
USPC 345/173

(57) ABSTRACT

An electronic device includes a touch screen unit; and a controller for, when an application is executed, changing the touch reactivity of the touch screen unit in accordance with the application.

### CROSS-REFERENCE TO RELATED APPLICATION(S) AND CLAIM OF PRIORITY

The present application is related to and claims the priority under 35 U.S.C. §119(a) to Korean Application Serial No. 10-2013-0099694, which was filed in the Korean Intellectual Property Office on Aug. 22, 2013 the entire content of which is hereby incorporated by reference.

### TECHNICAL FIELD

This disclosure generally relates to an electronic device and a method of controlling touch reactivity of the electronic device, and more particularly, to an electronic device and a method of controlling touch reactivity of the electronic device capable of improving a touch capability of the electronic device.

### BACKGROUND

A portable terminal stores various applications executable by a user, and the various applications include applications giving priority to touch reactivity and applications giving priority to touch linearity.

The applications giving priority to the touch reactivity correspond to applications giving priority to reactivity of a touch such as page switching or scrolling, and may include, for example, a gallery application storing image data.

Further, the applications giving priority to the touch linearity correspond to applications converting an input to a line such as drawing a line, and may include, for example, a memo application.

### SUMMARY

To address the above-discussed deficiencies, it is a primary object to provide an application giving priority to touch reactivity and an application giving priority to touch linearity have a trade-off relation, the touch linearity deteriorates when the touch reactivity improves. Currently, although the touch performance is maintained by the same parameter value within a range which does not influence the touch reactivity and the touch linearity, it makes the user sensitive to a touch reaction feel inconvenience when the application giving priority to the touch reactivity is executed.

Accordingly, various embodiments of the present disclosure may provide an electronic device capable of improving the touch performance and a method of controlling touch reactivity of the electronic device.

Further, various embodiments of the present disclosure may provide an electronic device capable of improving the touch performance for each type of the application and a method of controlling touch reactivity of the electronic device.

In accordance with an aspect of the present disclosure, an electronic device is provided. The electronic device includes: a touch screen unit; and a controller configured to, when an application is executed, change touch reactivity of the touch screen unit in accordance with the application.

In accordance with another aspect of the present disclosure, a method of controlling touch reactivity by an electronic device is provided. The method includes: determining execution of an application; and changing touch reactivity of a touch screen unit in accordance with the application when the application is executed.

The electronic device and the method of controlling the touch reactivity of the electronic device according to various embodiments of the present disclosure can improve touch performance of the application closely related with the touch reactivity in the electronic device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of an exemplary embodiment of an electronic device according to this disclosure;

FIG. 2 is a flowchart illustrating an exemplary embodiment of an operation of controlling touch reactivity according to a type of an application by an electronic device according to this disclosure;

FIG. 3 is a flowchart illustrating an exemplary embodiment of an operation of controlling touch reactivity according to a type of an application by an electronic device according to this disclosure;

FIG. 4 is a flowchart illustrating an exemplary embodiment of an operation of controlling touch reactivity according to a type of an application by an electronic device according to this disclosure;

FIG. 5 is a flowchart illustrating an exemplary embodiment of an operation of controlling touch reactivity according to a type of an application by an electronic device according to this disclosure;

FIG. 6 is a flowchart illustrating an exemplary embodiment of an operation of setting a reactivity-prioritized application in an electronic device according to this disclosure;

FIG. 7 is a flowchart illustrating an exemplary embodiment of an operation of controlling touch reactivity according to a type of an application executed by an electronic device according to this disclosure; and

FIG. 8A illustrates an exemplary embodiment of a result of a test on touch reactivity or touch linearity according to a change in a parameter value for controlling the touch reactivity in an electronic device according to this disclosure.

FIG. 8B illustrates an exemplary embodiment of a result of a test on touch reactivity or touch linearity according to a change in a parameter value for controlling the touch reactivity in an electronic device according to this disclosure.

### DETAILED DESCRIPTION

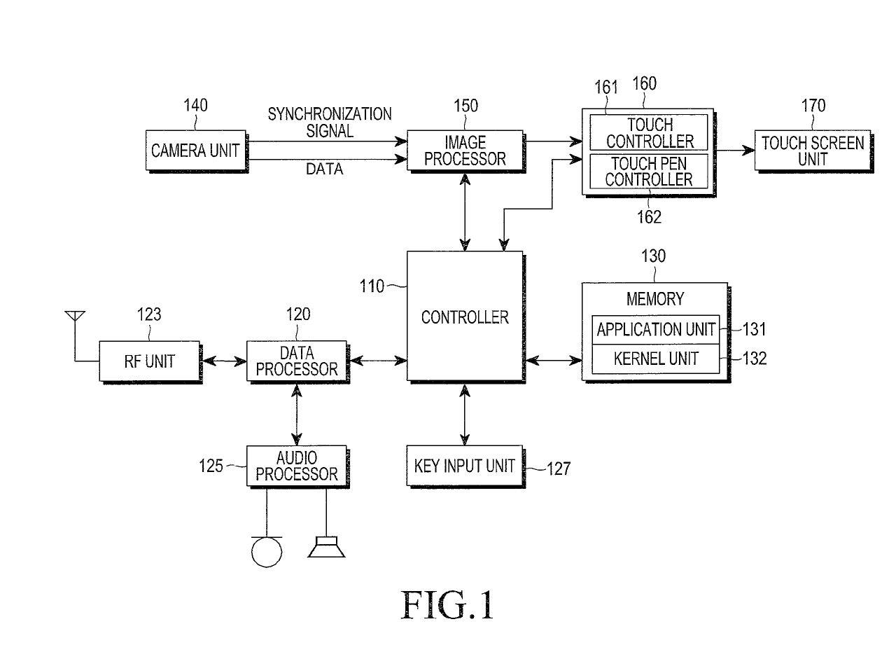

FIGS. 1 through 8B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or method. Hereinafter, exemplary embodiments of the present disclosure will be described in detail with reference to the accompanying drawings. It shall be noted that in the following description, the same elements will be designated by the same reference numerals although they are shown in different drawings.

An electronic device according to various embodiments of the present disclosure includes a portable terminal and a stationary terminal. Here, the portable terminal corresponds to an easily carried and movable electronic device, which may be a video phone, a mobile phone, a smart phone, a WCDMA terminal, a Universal Mobile Telecommunication Service (UMTS) terminal, a Personal Digital Assistant (PDA), a Portable Multimedia Player (PMP), a Digital Multimedia Broadcasting (DMB) terminal, an e-book, a portable computer (notebook, tablet PC or the like), a digital camera or the like. Further, the fixed terminal includes a desktop personal computer or the like.

In various embodiments of the present disclosure, a reactivity-prioritized application refers to an application closely related with touch reactivity.

In various embodiments of the present disclosure, the reactivity-prioritized application corresponds to an application that gives priority to reactivity of a touch such as page switching or scrolling, and may include, for example, a gallery application or a launcher menu. A linearity-prioritized application corresponds to an application that converts a touch input to a line such as drawing a line rather than the touch reactivity, and may include, for example, a memo application.

In various embodiments of the present disclosure, although a first value set as a default value of a touch controller or a touch pen controller is considered as a first jitter value and a second value set to the touch controller or the touch pen controller according to the reactivity-prioritized application or a type of an executed application is considered as a second jitter value, various embodiments of the present disclosure are not limited by the above terms.

FIG. 1 is a block diagram of an exemplary embodiment of an electronic device according to this disclosure.

Referring to FIG. 1, a Radio Frequency (FR) unit 123 performs a wireless communication function of the electronic device. The RF unit 123 includes an RF transmitter for up-converting and amplifying a frequency of a transmitted signal and an RF receiver for low noise-amplifying a received signal and down-converting a frequency. A data processor 120 may include a transmitter for coding and modulating the transmitted signal and a receiver for decoding and demodulating the received signal. The data processor 120 may consist of a MOdulation DEMdulation (MODEM) and a COder DECoder (CODEC). The codec may include a data codec for processing packet data and the like and an audio codec for processing an audio signal such as a voice. An audio processor 125 may perform a function of reproducing a received audio signal output from the audio codec of the data processor 120 or transmitting a transmitted audio signal generated from a microphone to the audio codec of the data processor 120.

A key input unit 127 may include keys for inputting number and character information and function keys for setting various functions.

A memory 130 may include a program memory and data memories. The program memory may store a program for controlling a general operation of the electronic device and programs for controlling touch reactivity for each type of the application. Further, the data memory may perform a function of temporarily storing data generated during executions of the programs.

The memory 130 may store an application unit 131 and a kernel unit 132 which can improve touch reactivity of the reactivity-prioritized application under a control of a controller 110 according to various embodiments of the present disclosure. The application unit 131 and the kernel unit 132 are loaded to the controller 110, and the controller 110 may execute the application unit 131 and the kernel unit 132 to change the touch reactivity of the touch screen unit 170 according to execution of an application.

When it is determined to execute the reactivity-prioritized application, the application unit 131 may transmit a second jitter value for the reactivity-prioritized application to the kernel unit 132. When the execution of the reactivity-prioritized application ends, the application unit 131 may transmit a first jitter value set as a default value to the kernel unit 132.

Further, when it is determined to execute the reactivity-prioritized application, the application unit 131 may transmit second jitter values for the reactivity-prioritized application with respect to the touch controller 161 and the touch pen controller 162 to the kernel unit 132. When the execution of the reactivity-prioritized application ends, the application unit 131 may transmit first jitter values set as default values with respect to the touch controller 161 and the touch pen controller 161 to the kernel unit 132.

When a particular application switched to a foreground among a plurality of applications which are being executed is determined as the reactivity-prioritized application, the application unit 131 may transmit the second jitter value for the reactivity-prioritized application to the kernel unit 132. When the particular application is switched to a background, the application unit 131 may transmit the first jitter value set as the default value to the kernel unit 132.

When a level of the touch reactivity of the application which is being executed is changed, the application unit 131 may transmit the second jitter value corresponding to the changed level of the touch reactivity to the kernel unit 132. When the execution of the application of which the level of the reactivity has been changed ends, the application unit 131 may transmit the first jitter value set as the default value to the kernel unit 132.

Further, the application unit 131 may determine a type of the application which is being executed, detect the second jitter value corresponding to the application which is being executed from the memory 130, and transmit the detected second jitter value to the kernel unit 132.

When the second jitter value for the reactivity-prioritized application is transmitted from the application unit 131, the kernel unit 132 may transmit the second jitter value for the reactivity-prioritized application to the touch controller 161 and change the first jitter value set as the default value of the touch controller 161 into the second jitter value. When the first jitter value set as the default value is transmitted from the application unit 131, the kernel unit 132 may transmit the first jitter value set as the default value to the touch controller 161 and change the second jitter value of the touch controller 161 into the first jitter value set as the default value, so as to return the second jitter value to the first jitter value.

When the second jitter values for the reactivity-prioritized application with respect to the touch controller and the touch pen controller are transmitted from the application unit 131, the kernel unit 132 may transmit the second jitter values for the reactivity-prioritized application with respect to the touch controller 161 and the touch pen controller 162 to the touch controller and the touch pen controller, respectively, and change the first jitter values set as the default values for the touch controller 161 and the touch pen controller 162 into the second jitter values. When the first jitter values set as the default values for the touch controller 161 and the touch pen controller 162 are transmitted from the application unit 131, the kernel unit 132 may transmit the first jitter values set as the default values for the touch controller 161 and the touch pen controller 162 to the touch controller 161 and the touch pen controller 162, respectively, and change the second jitter values for the touch controller 161 and the touch pen controller 162 into the first jitter values set as the default values, so as to return the second jitter values to the first jitter values.

In various embodiments of the present disclosure, although it is described, as an example, that a register value of the touch controller 161 or the touch pen controller 162 is changed through the application unit 131 and the kernel unit 132 when the reactivity-prioritized application is executed, the same change can be made through the controller 110.

The memory 130 may store the reactivity-prioritized applications which are automatically or manually classified from a plurality of applications stored in the electronic device according to various embodiments of the present disclosure. The classified reactivity-prioritized applications may be stored after being applied to one of levels of the touch reactivity, for example, good, fair, and poor automatically according to a user's preference or priority or manually according to a user's selection. Further, the memory 130 stores the second jitter value for the reactivity-prioritized application, and the second jitter value may include a plurality of sub jitter values corresponding to the touch reactivity levels of the reactivity-prioritized applications.

In addition, with respect to each of one or more of the classified reactivity-prioritized applications, the memory 130 may store the second jitter value for the reactivity-prioritized application with respect to the touch controller 161 and the second jitter value for the reactivity-prioritized application with respect to the touch pen controller 162. The second jitter value for the reactivity-prioritized application with respect to the touch controller 161 and the second jitter value for the reactivity-prioritized application with respect to the touch pen controller 162 may be different or the same.

The memory 130 may store the second jitter value corresponding to a type of an application. At this time, the second jitter value corresponding to the type of the application may include a plurality of sub jitter values corresponding to the number of applications.

When the plurality of applications stored in the electronic device are classified into the reactivity-prioritized application and the linearity-prioritized application, the memory 130 may store each of the second jitter value corresponding to the reactivity-prioritized application and the second jitter value corresponding to the linearity-prioritized application.

The controller 110 performs a function of controlling a general operation of the electronic device.

According to various embodiments of the present disclosure, the controller 110 may execute the application unit 131 and the kernel unit 132 loaded to the controller 110 to change the touch reactivity of the touch screen unit 170 in accordance with an executed application. The controller 110 may change the touch reactivity of the touch screen unit 170 in accordance with an executed reactivity-prioritized application. The controller 110 may change the touch reactivity of the touch screen unit 170 in accordance with a reactivity-prioritized application which has been switched to the foreground among a plurality of execution applications. The controller 110 may change the touch reactivity of the touch screen unit 170 in accordance with a level of touch reactivity selected by the user.

When a control of the touch reactivity is selected during the execution of the application, the controller 110 may perform switching to a touch reactivity control mode according to various embodiments of the present disclosure. The controller 110 may change and set the level of the touch reactivity of the application which is being executed in the touch reactivity control mode as a selected level of the touch reactivity.

When a downloaded application is the reactivity-prioritized application, the controller 110 may classify the downloaded application as the reactivity-prioritized application according to various embodiments of the present disclosure. Further, the controller 110 may automatically set to apply the level of the touch reactivity according to the user's preference or priority to the downloaded application.

In the touch reactivity control mode of the application, the controller 110 may set one or more applications selected by the user as the reactivity-prioritized application, and change and set levels of the touch reactivity of the one or more applications as levels of the touch reactivity selected by the user according to various embodiments of the present disclosure.

A camera unit 140 includes a camera sensor for photographing image data and converting a photographed optical signal to an electrical signal and a signal processor for converting an analog image signal photographed by the camera sensor to digital data. It is assumed that the camera sensor is CCD or CMOS, and the signal processor may be implemented by a Digital Signal Processor (DSP). The camera sensor and the signal processor may be implemented integrally or separately.

An image processor 150 performs Image Signal Processing (ISP) for displaying an image signal output from the camera unit 140 on a display unit 160, and the ISP executes functions such as gamma correction, interpolation, spatial change, image effect, image scale, AWB, AE, AF and the like. Accordingly, the image processor 150 processes the image signal output from the camera unit 140 in the unit of frames and outputs the frame image data to fit a characteristic and a size of the display unit 160. Further, the image processor 150 includes an image codec and performs a function of compressing the frame image data displayed on a display unit 160 in a preset way or returns the compressed frame image data to the original frame image data. The image codec may be JPEG codec, MPEG4 codec, or Wavelet codec. It is assumed that the image processor 150 has an On Screen Display (OSD) function, and the image processor 150 may output on screen display data according to a displayed screen size under a control of the controller 110.

A touch screen unit 170 may provide user interfaces corresponding to various services (for example, a call, data transmission, broadcasting, and photography) to the user. The touch screen unit 170 may transmit an analog signal corresponding to at least one touch input into the user interface to the touch controller 161 or the touch pen controller 162. The touch screen unit 170 may receive at least one touch through a user's body (for example, fingers including a thumb) or a touchable input means (for example, a stylus pen). Further, the touch screen unit 170 may receive successive motions of one touch among the at least one touch. The touch screen unit 170 may transmit an analog signal corresponding to the successive motions of the input touch to the touch controller 161 or the touch pen controller 162.

In various embodiments of the present disclosure, the touch is not limited to the contact between the touch screen unit 170 and the user's body or the touchable input means, and may include a non-contact (for example, a case where a detectable interval between the touch screen 170 and the user's body or the touchable input means is smaller than or equal to 1 mm). The detectable interval of the touch screen 170 may be changed according to a capability or structure of the electronic device.

The touch screen unit 170 may be implemented in a resistive type, a capacitive type, an infrared type, or an acoustic wave type.

The touch controller 161 may receive an analog signal corresponding to at least one touch input through the user's body (for example, fingers including a thumb) on the touch screen unit 170, convert the received analog signal to a digital signal (for example, X and Y coordinates), and transmit the converted digital signal to the controller 110. The touch controller 161 may be set to have a parameter value for the reactivity-prioritized application by the kernel unit 132, and thus a register value set as the default value may be changed according to various embodiments of the present disclosure. Further, the touch pen controller 161 may be set to have a parameter value set as the default value by the kernel unit 132 and thus return to a register value set as the default value. According to various embodiments of the present disclosure, the touch controller 161 may be TSP IC.

The touch pen controller 162 may receive an analog signal corresponding to at least one touch input through the touchable input means (for example, a stylus pen) on the touch screen unit 170, convert the received analog signal to a digital signal (for example, X and Y coordinates), and transmit the converted digital signal to the controller 110. The touch pen controller 162 may be set to have a parameter value for the reactivity-prioritized application by the kernel unit 132, and thus a register value set as the default value may be changed according to various embodiments of the present disclosure. The touch pen controller 162 may be set to have a parameter value set as the default value by the kernel unit 132 and thus return to a register value set as the default value. According to various embodiments of the present disclosure, the touch controller 161 may be WACOM IC.

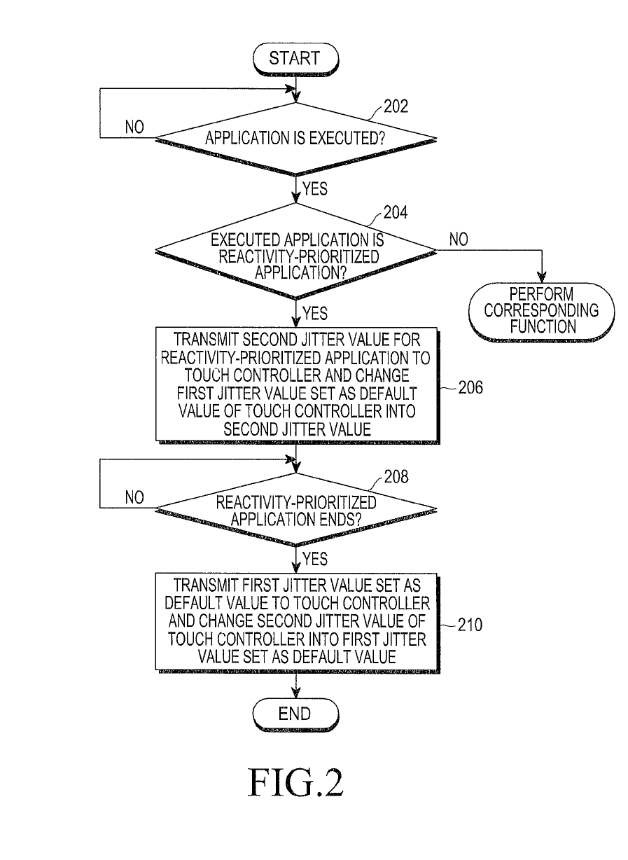

An operation of controlling the touch reactivity according to a type of the application by the electronic device will be described in detail with reference to FIGS. 2 through 6.

FIG. 2 is a flowchart illustrating an exemplary embodiment of an operation of controlling touch reactivity according to a type of an application by an electronic device according to this disclosure.

Referring to FIG. 2, when an application is executed in step 202, the application unit 131 may determine whether the executed application is the reactivity-prioritized application through the memory 130. When it is determined that the executed application is the reactivity-prioritized application in step 204, the application unit 131 may detect a second jitter value for the reactivity-prioritized application from the memory 130 and the detected second jitter value may be transmitted by the kernel unit 132 in step 206.

The detected second jitter value may include a plurality of different sub jitter values according to a level of the touch reactivity preset to the executed application. For example, when the level of the touch reactivity is classified into good, fair, and poor, the reactivity-prioritized application may be set to have one of the levels such as good, fair, and poor, and the second jitter value also may include a plurality of sub jitter values corresponding to the levels such as good, fair, and poor.

In step 206, the kernel unit 132 may transmit the second jitter value for the reactivity-prioritized application transmitted from the application unit 131 to the touch controller 161 and change a first jitter value set as the default value of the touch controller 161 into the second jitter value.

During the execution of the application in a state where the touch reactivity has been improved by changing the value of the touch controller 161 into the second jitter value for the reactivity-prioritized application, when it is determined that the application ends in step 208, the application unit 131 may transmit the first jitter value set as the default value to the kernel unit 132 in step 210. In step 210, The kernel unit 132 may transmit the first jitter value set as the default value transmitted from the application unit 131 to the touch controller 161 and change the second jitter value for the reactivity-prioritized application set to the touch controller 161 into the first jitter value set as the default value, so as to return the second jitter value to the first jitter value.

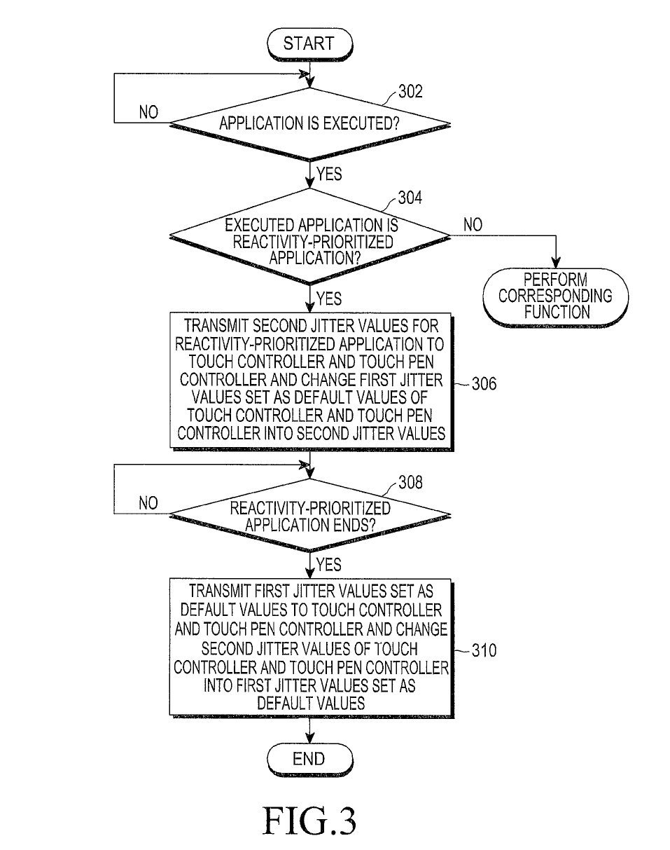

FIG. 3 is a flowchart illustrating an exemplary embodiment of an operation of controlling touch reactivity according to a type of an application by an electronic device according to this disclosure. Referring to FIG. 3, when an application is executed in step 302, the application unit 131 may determine whether the executed application is the reactivity-prioritized application through the memory 130. When it is determined that the executed application is the reactivity-prioritized application in step 304, the application unit 131 may detect a second jitter value for the reactivity-prioritized application with respect to the touch controller 161 and a second jitter value for the reactivity-prioritized application with respect to the touch pen controller 162 from the memory 130 and the detected second jitter values may be transmitted by the kernel unit 132 in step 306.

Each of the detected second jitter values may include a plurality of different sub jitter values according to a level of the touch reactivity preset to the application which is being executed. For example, when the level of the touch reactivity is classified into good, fair, and poor, the reactivity-prioritized application may be set to have one of the levels such as good, fair, and poor, and the second jitter value also may include a plurality of sub jitter values corresponding to the levels such as good, fair, and poor.

In step 306, the kernel unit 132 may transmit the second jitter value for the reactivity-prioritized application transmitted from the application unit 131 to the touch controller 161 and change a first jitter value set as the default value of the touch controller 161 into the second jitter value.

Further, in step 306, the kernel unit 132 may transmit the second jitter value for the reactivity-prioritized application transmitted from the application unit 131 to the touch pen controller 162 and change a first jitter value set as the default value of the touch controller 162 into the second jitter value.

During the execution of the application in a state where the touch reactivity has been improved by changing the values of the touch controller 161 and the touch pen controller 162 into the second jitter values, it may be determined whether the execution of the application ends in step 308. When it is determined that the execution of the application ends in step 308, the application unit 131 may transmit the first jitter value set by default for the touch controller 161 and the second jitter value set by default for the touch pen controller 162 to the kernel unit 132 in step 310. In step 310, the kernel unit 132 may transmit the first jitter value set by default for the touch controller 161 and the first jitter value set by default for the touch pen controller 162 transmitted from the application unit 131 to the touch controller 161 and the touch pen controller 162, respectively. Then, in step 310, the second jitter values for the reactivity-prioritized application set to the touch controller 161 and the touch pen controller 162 are changed into the first jitter values set as the default values and thus the second jitter values may be returned.

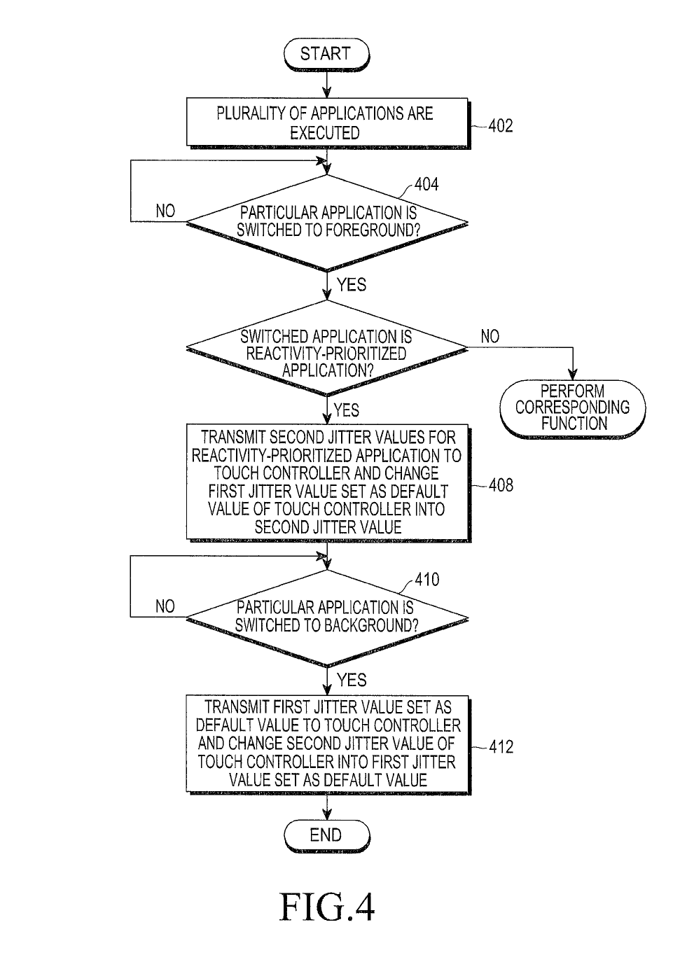

FIG. 4 is a flowchart illustrating an exemplary embodiment of an operation of controlling touch reactivity according to a type of an application by an electronic device according to this disclosure.

Referring to FIG. 4, during executions of a plurality of applications in step 402, it may be determined whether there is an application switched to a foreground in step 404. When it is determined that a particular application among the plurality of applications is switched to the foreground in step 404, the application unit 131 may determine whether the particular application switched to the foreground is the reactivity-prioritized application through the memory. When it is determined that the executed application is the reactivity-prioritized application in step 406, the application unit 131 may detect a second jitter value for the reactivity-prioritized application from the memory 130 and the detected second jitter value may be transmitted by the kernel unit 132 in step 408.

The detected second jitter value may include a plurality of different sub jitter values according to a level of the touch reactivity preset to the particular application switched to the foreground. For example, when the level of the touch reactivity is classified into good, fair, and poor, the reactivity-prioritized application may be set to have one of the levels such as good, fair, and poor, and the second jitter value also may include a plurality of sub jitter values corresponding to the levels such as good, fair, and poor.

In step 408, the kernel unit 132 may transmit the second jitter value for the reactivity-prioritized application transmitted from the application unit 131 to the touch controller 161 and change a first jitter value set as the default value of the touch controller 161 into the second jitter value.

During the execution of the particular application in a state where the touch reactivity has been improved by changing the value of the touch controller 161 into the second jitter value for the reactivity-prioritized application, when it is determined that the particular application is switched to the background in step 410, the application unit 131 may transmit the first jitter value set as the default value to the kernel unit 132 in step 412. In step 412, The kernel unit 132 may transmit the first jitter value set as the default value transmitted from the application unit 131 to the touch controller 161 and change the second jitter value for the reactivity-prioritized application set to the touch controller 161 into the first jitter value set as the default value, so as to return the second jitter value to the first jitter value.

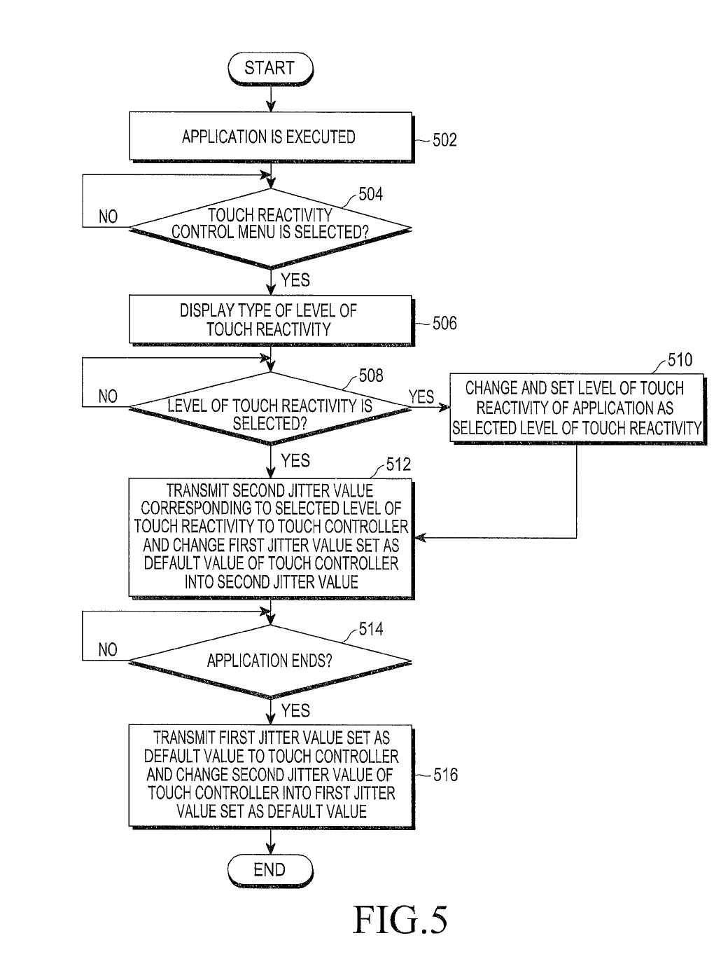

FIG. 5 is a flowchart illustrating an exemplary embodiment of an operation of controlling touch reactivity according to a type of an application by an electronic device according to this disclosure.

Referring to FIG. 5, during the execution of the application in step 502, the controller 110 may determine whether a touch reactivity control menu is selected in step 504. When it is determined that the touch reactivity control menu is selected in step 504, the controller 110 may perform switching to the touch reactivity control mode and display types of levels (for example, “good, fair, and poor”) of the touch reactivity selectable in the touch reactivity control mode in step 506. The controller 110 may determine whether the level of the touch reactivity is selected from the displayed types of the levels of the touch reactivity in step 508. When it is determined that the level of the touch reactivity is selected by the user in step 508, the controller 110 may change and set a level of the touch reactivity of the application which is being executed as the selected level of the touch reactivity in step 510.

According to a change in the level of the touch reactivity for the application which is being executed, the controller 110 may classify and store the executed application as the reactivity-prioritized application. For example, when the level of the touch reactivity selected by the user is equal to or higher than a predetermined level (for example, equal to or higher than “fair” among “good, fair, and poor”), the controller 110 may classify and store the executed application as the reactivity-prioritized application.

Alternatively, when the application unit 131 determines the application executed in step 502 as the reactivity-prioritized application and transmits the fact that the executed application is the reactivity-prioritized application to the controller 110, the controller 110 may control the executed application to display a notice message indicating that the application is the reactivity-prioritized application capable of controlling the touch reactivity.

When the level of the touch reactivity of the executed application is changed in step 510, the application unit 131 may detect the second jitter value (a corresponding sub jitter value among the plurality of sub jitter values included in the second jitter value) corresponding to the changed level of the touch reactivity and transmit the detected second jitter value to the kernel unit 132 in step 512.

In step 512, the kernel unit 132 may transmit the second jitter value for the reactivity-prioritized application transmitted from the application unit 131 to the touch controller 161 and change a first jitter value set as the default value of the touch controller 161 into the second jitter value.

During the execution of the application in a state where the touch reactivity has been improved by changing a register value of the touch controller 161, when it is determined that the execution of the application ends in step 514, the application unit 131 may transmit the first jitter value set as the default value to the kernel unit 132 in step 516. In step 516, the kernel unit 132 may transmit the first jitter value set as the default value transmitted from the application unit 131 to the touch controller 161 and change the changed second jitter value set to the touch controller 161 into the first jitter value set as the default value, so as to return the second jitter value to the first jitter value.

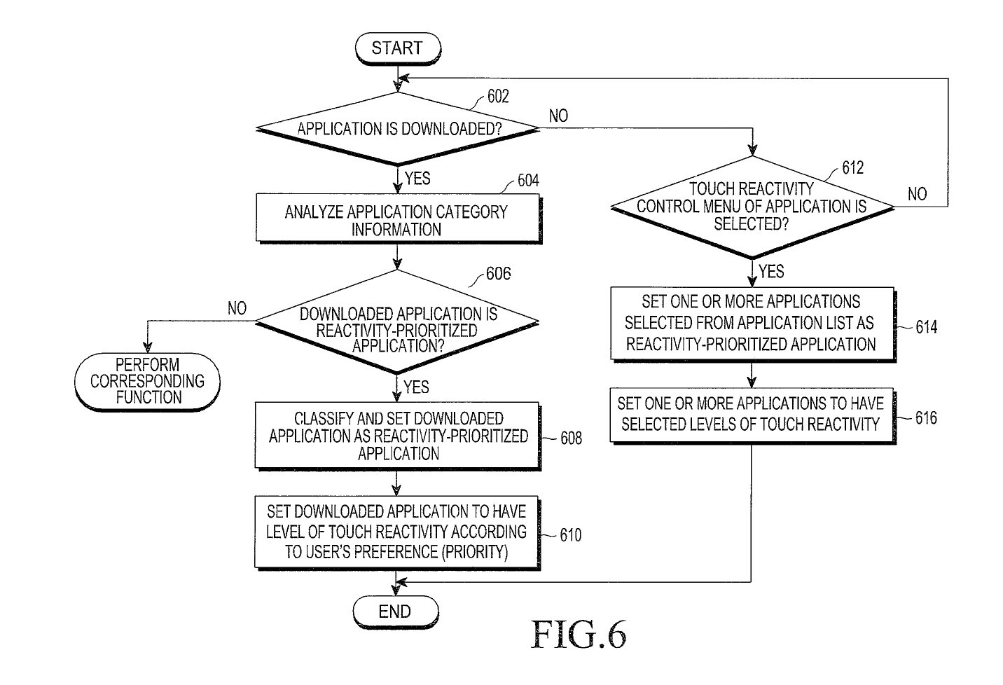

FIG. 6 is a flowchart illustrating an exemplary embodiment of an operation of setting a reactivity-prioritized application in an electronic device according to this disclosure.

Referring to FIG. 6, when it is determined to download the application by the electronic device in step 602, the controller 110 may determine category information of the application through metadata of the downloaded application in step 604. As a result of the determination of the category information of the downloaded application, when the downloaded application is the reactivity-prioritized application in step 606, the controller 110 may classify and set the downloaded application as the reactivity-prioritized application in step 608. Further, the controller 110 may automatically set a level (for example, “good, fair, or poor”) of the touch reactivity of the downloaded application according to a user's preference or priority selected by the user based on frequency of use of the application in step 610.

Alternatively, when a touch reactivity control menu of the application is selected in step 612, the controller 110 may perform switching to an application control mode. In the application control mode, the controller 110 may display a plurality of application lists for selecting the reactivity-prioritized application in step 614. In step 614, when one or more applications are selected from the plurality of application lists, the controller 110 may set the one or more selected applications as the reactivity-prioritized application.

Further, when types of the levels of the touch reactivity are automatically or manually displayed in step 616, the controller 110 may set one or more levels of the touch reactivity selected by the user as the levels of the touch reactivity with respect to the one or more applications set as the reactivity-prioritized application.

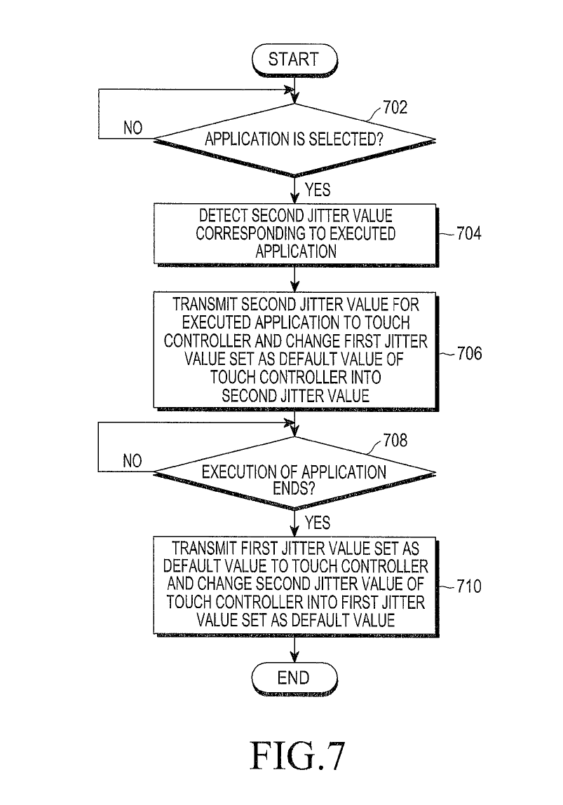

FIG. 7 is a flowchart illustrating an exemplary embodiment of an operation of controlling touch reactivity according to a type of an application executed by an electronic device according to this disclosure.

Referring to FIG. 7, when an application is executed in step 702, the application unit 131 may detect a second jitter value (a corresponding sub jitter value among a plurality of sub jitter values included in the second jitter value) corresponding to the executed application through the memory 130 in step 704 and transmit the detected second jitter value to the kernel unit 132 in step 706. In step 706, the kernel unit 132 may transmit the second jitter value transmitted from the application unit 131 to the touch controller 161 and change a first jitter value set as the default value of the touch controller 161 into the second jitter value for the executed application.

During the execution of the application in a state where the value of the touch controller 161 is changed into a register value corresponding to the executed application, when it is determined that the execution of the application ends in step 708, the application unit 131 may transmit the first jitter value set as the default value to the kernel unit 132 in step 710. In step 710, The kernel unit 132 may transmit the first jitter value set as the default value transmitted from the application unit 131 to the touch controller 161 and change the second jitter value for the executed application set to the touch controller 161 into the first jitter value set as the default value, so as to return the second jitter value to the first jitter value.

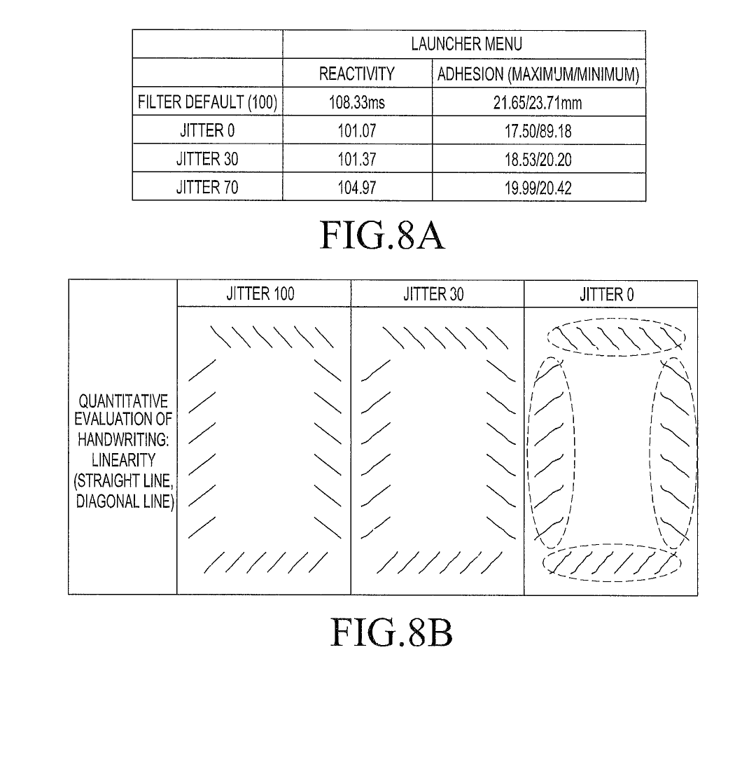

FIGS. 8A and 8B illustrate an exemplary embodiment of a result of a test on the touch reactivity or the touch linearity according to a change in the jitter value for controlling the touch reactivity in the electronic device according to this disclosure.

In FIG. 8A, shows the fact that reactivity and adhesion of the touch are improved as the jitter value decreases if the reactivity-prioritized application is executed when the jitter value (filter default) set as the default value is “100”. For example, as shown in FIG. 8A, when the jitter value is “0” among values “0, 30, and 70”, the reactivity and the adhesion of the touch are improved.

In FIG. 8B, when the linearity-prioritized application is executed, linearity of the linearity-prioritized application is improved as the jitter value increases. As shown in FIG. 8B, when the jitter value is “100” among values “100, 30, and 0”, the linearity of the touch is improved.

FIGS. 8A and 8B show a trade-off relation in which while the reactivity and the adhesion of the reactivity-prioritized application increase but the linearity of the linearity-prioritized application decreases as the jitter value decreases, the reactivity and the adhesion of the reactivity-prioritized application decrease but the linearity of the linearity-prioritized application increases as the jitter value increases.

The electronic device and the method of controlling the touch reactivity of the electronic device according to various embodiments of the present disclosure can be implemented by a computer-readable code stored in a computer-readable recording medium. The computer-readable recording medium includes all the types of recording devices in which data readable by a computer system are stored.

As for such a recording medium, for example, a ROM, a RAM, an optical disc, a magnetic tape, a floppy disc, a hard disc, or a non-volatile memory may be used, and a medium implemented in a type of carrier wave (for example, transmission through the Internet) may also be included in such a recording medium. In addition, the computer-readable recording medium may be stored with codes which are distributed in computer systems connected by a network such that the codes can be read and executed by a computer in a distributed method.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a touch screen unit; and
a controller configured to, when an application is executed, change touch reactivity of the touch screen unit in accordance with the application.

2. The electronic device of claim 1, wherein the controller changes the touch reactivity to a state before the execution of the application when execution of the application ends.

3. The electronic device of claim 1, wherein the controller comprises:
an application unit configured to transmit a second value for changing the touch reactivity in accordance with the application to a kernel unit when the application is executed and transmitting a first value for setting the touch reactivity by default to the kernel unit when execution of the application ends; and
the kernel unit configured to change the touch reactivity to the second value from the first value when receiving the second value from the application unit and changing the touch reactivity to the first value from the second value when receiving the first value from the application unit.

4. The electronic device of claim 3, wherein the kernel unit transmits the first value or the second value to at least one of a touch controller and a touch pen controller for controlling the touch screen unit to change the touch reactivity of the touch screen unit.

5. The electronic device of claim 1, wherein, when the application is determined as a reactivity-prioritized application, the controller changes the touch reactivity of the touch screen unit in accordance with the reactivity-prioritized application.

6. The electronic device of claim 5, wherein the controller comprises an application unit configured to transmit a second value for changing the touch reactivity in accordance with the reactivity-prioritized application to the kernel unit when the reactivity-prioritized application is executed and transmitting a first value for setting the touch reactivity by default to the kernel unit when execution of the reactivity-prioritized application ends.

7. The electronic device of claim 1, wherein, when the application is determined as a reactivity-prioritized application which has been switched to the foreground among a plurality of execution applications, the controller changes the touch reactivity of the touch screen unit in accordance with the reactivity-prioritized application.

8. The electronic device of claim 7, wherein the controller changes the touch reactivity to a state before the execution of the reactivity-prioritized application when the reactivity-prioritized application is switched to the background.

9. The electronic device of claim 7, wherein the controller comprises an application unit configured to transmit a second value for changing the touch reactivity in accordance with the reactivity-prioritized application to the kernel unit when the reactivity-prioritized application switched to the foreground is executed and transmitting a first value for setting the touch reactivity by default to the kernel unit when the reactivity-prioritized application is switched to the background.

10. The electronic device of claim 1, wherein the controller displays level types of the touch reactivity when a change in the touch reactivity of the touch screen unit is selected during the execution of the application and changes the touch reactivity of the touch screen unit in accordance with a level of the touch reactivity selected from the level types of the touch reactivity.

11. The electronic device of claim 10, wherein the controller comprises an application unit configured to transmit a second value for changing the touch reactivity in accordance with the selected level of the touch reactivity to the kernel unit and transmitting a first value for setting the touch reactivity by default to the kernel unit when the execution of the application ends.

12. The electronic device of claim 1, wherein, when an application downloaded using a category analysis is determined as a reactivity-prioritized application, the controller classifies the downloaded application as the reactivity-prioritized application and sets a level of the touch reactivity of the downloaded application which is classified as the reactivity-prioritized application according to user preference or priority.

13. The electronic device of claim 12, wherein the downloaded application is classified as the reactivity-prioritized application or the level of the touch reactivity is set automatically or manually.

14. A method of controlling touch reactivity by an electronic device, the method comprising:
determining execution of an application; and
changing touch reactivity of a touch screen unit in accordance with the application when the application is executed.

15. The method of claim 14, further comprising changing the touch reactivity to a state before the execution of the application when execution of the application ends.

16. The method of claim 14, wherein the changing of the touch reactivity comprises:
changing a first value for configuring the touch reactivity by default to a second value for changing the touch reactivity in accordance with the application when the application is executed; and
changing the touch reactivity to the first value from the second value when the execution of the application ends.

17. The method of claim 16, further comprising transmitting the first value or the second value to at least one of a touch controller and a touch pen controller for controlling the touch screen unit to change the touch reactivity of the touch screen unit.

18. The method of claim 14, wherein the changing of the touch reactivity comprises, when the application is determined as a reactivity-prioritized application, changing the touch reactivity of the touch screen unit in accordance with the reactivity-prioritized application.

19. The method of claim 18, wherein the changing of the touch reactivity of the touch screen unit in accordance with the reactivity-prioritized application comprises:
changing a first value for configuring the touch reactivity by default to a second value for changing the touch reactivity in accordance with the reactivity-prioritized application when the reactivity-prioritized is executed; and
changing the touch reactivity to the first value from the second value when the execution of the reactivity-prioritized application ends.

20. The method of claim 14, wherein the changing of the touch reactivity comprises, when the application is determined as a reactivity-prioritized application which is switched to the foreground among a plurality of execution applications, changing the touch reactivity of the touch screen unit in accordance with the reactivity-prioritized application.

21. The method of claim 20, further comprising, when the reactivity-prioritized application is switched to the background, changing the touch reactivity to a state before the execution of the reactivity-prioritized application.

22. The method of claim 20, wherein the changing of the touch reactivity of the touch screen unit in accordance with the reactivity-prioritized application comprises:
changing a first value for configuring the touch reactivity by default to a second value for changing the touch reactivity in accordance with the reactivity-prioritized application when the reactivity-prioritized application switched to the foreground is executed; and
changing the touch reactivity to the first value from the second value when the reactivity-prioritized application is switched to the background.

23. The method of claim 14, further comprising:
displaying level types of the touch reactivity when a change in the touch reactivity of the touch screen unit is selected during the execution of the application; and
changing the touch reactivity of the touch screen unit in accordance with a level of the touch reactivity selected from the level types of the touch reactivity.

24. The method of claim 23, wherein the changing of the touch reactivity of the touch screen unit in accordance with the level of the touch reactivity selected from the level types of the touch reactivity comprises:
changing a first value for configuring the touch reactivity by default to a second value for changing the touch reactivity in accordance with the selected level of the touch reactivity; and
changing the touch reactivity to the first value from the second value when execution of the application ends.

25. The method of claim 14, further comprising:
when an application downloaded using a category analysis is determined as the reactivity-prioritized application, classifying the downloaded application as the reactivity-prioritized application; and
setting a level of the touch reactivity of the downloaded application which is classified as the reactivity-prioritized application according to user preference or priority.

26. The method of claim 25, wherein the downloaded application is classified as the reactivity-prioritized application or a level of the touch reactivity is set automatically or manually.
